(19) United States
(12) Patent Application Publication
(10) Pub. No.: US 2019/0243341 A1
(43) Pub. Date: Aug. 8, 2019

(54) PROGRAM STORAGE DEVICE AND PROGRAM STORAGE SYSTEM

(71) Applicant: Fanuc Corporation, Minamitsuru-gun (JP)

(72) Inventor: Kousuke Uno, Minamitsuru-gun (JP)

(73) Assignee: Fanuc Corporation, Minamitsuru-gun (JP)

(21) Appl. No.: 16/266,583

(22) Filed: Feb. 4, 2019

(30) Foreign Application Priority Data
Feb. 5, 2018 (JP) 2018-018724

(51) Int. Cl. G05B 19/4093; G05B 19/4155; G05B 19/418

(52) U.S. Cl. CPC G05B 19/40937; G05B 19/4155; G05B 2219/32161; G05B 2219/31422; G05B 2219/36395; G05B 19/4185

(57) ABSTRACT

Provided is a program storage device and a program storage system for transferring an appropriate program in advance to a numerical controller. A program storage device that transfers a program or page to a numerical controller includes: a statistical information collection unit that records at least a total number of times of transfer of the program or page transferred to the numerical controller; a prediction unit that predicts the program or page to be transferred subsequently, based on an execution state of the program in the numerical controller and the total number of times of transfer; and a program transfer control unit that transfers the predicted program or page.

### RELATED APPLICATIONS

The present application claims priority to Japanese Application Number 2018-018724 filed Feb. 5, 2018, the disclosure of which is hereby incorporated by reference herein in its entirety.

### BACKGROUND OF THE INVENTION

### 1. Field of the Invention

The present invention relates to a program storage device and a program storage system, and in particular to a program storage device and a program storage system for transferring an appropriate program in advance to a numerical controller.

### 2. Description of the Related Art

In addition to performing an operation by reading a machining program (hereinafter simply referred to as a program) stored in a storage area inside a numerical controller main body, the numerical controller includes a function of performing the operation by reading a program stored in a program storage device outside the numerical controller. Generally, the program storage device reads a program from a storage area in the program storage device in response to a request from the numerical controller, and transfers the program to the numerical controller.

FIG. 1 is a block diagram schematically illustrating a program storage system including a numerical controller and a program storage device in the related art. (1) A program execution unit of the numerical controller requests a program transfer control unit of the program storage device to transfer the program. (2) The program transfer control unit reads the program to be transferred from a program storage unit of the program storage device, and (3) transfer the program to a buffer of the numerical controller. (4) The program execution unit reads the program from the buffer and executes the program. (5) When the subsequent program to be executed does not exist in the buffer, the program execution unit requests the program transfer control unit of the program storage device to transfer the program.

Japanese Patent Application Laid-Open No. 11-110029 describes a configuration in which, when an NC program is transferred from an external device to a numerical controller, the program is transferred for each predetermined group. The group as referred to herein is a group of a main program, a sub-program, and the like for processing a specific workpiece, and is defined manually in advance.

In the program storage system of the related art as illustrated in FIG. 1, a delay (latency) sometimes occurs until the numerical controller can actually read the program after the numerical controller requests the program storage device to transfer the program. For example, a reduction in a transfer speed due to congestion of a high-speed serial bus (HSSB) connecting the numerical controller and the program storage device may be a cause of latency. The latency of program transfer adversely affects a cycle time and a quality of processing.

One solution is to transfer all the programs (including a main program, a sub-program called from the main program, and the like) that may be used in processing in advance to the numerical controller. In order to realize such a solution, it is necessary to have sufficient margin for a buffer capacity and a transfer rate of the numerical controller, which it is not realistic from the viewpoint of cost and the like at present.

As a method for avoiding such a problem, there is a method of predicting what kind of program is required in the near future and transferring only the predicted program to the numerical controller in advance (hereinafter referred to as pre-reading) However, even in the pre-reading method, there is a problem that the program to be transferred may not be predicted sufficiently in advance.

This problem will be described with reference to FIG. 2. For example, it is assumed that a main program (O1 (P.1)) has been transferred to a buffer of a numerical controller, and a program execution unit is executing the main program. A plurality of branch destinations are defined in the main program, and a sub-program (O9000 (P.1)) is called at one of the branch destinations. In this case, the program execution unit of the numerical controller cannot specify the sub-program to be requested to transfer to the program storage device unless the branch destination is determined. However, since the transfer of the sub-program is started after the branch destination is determined, there is a high possibility of occurrence of latency.

Japanese Patent Application Laid-Open No. 11-110029 is an example of a pre-reading method. Japanese Patent Application Laid-Open No. 11-110029 attempts to suppress the aforementioned problem, that is, an occurrence of latency by grouping a main program, a sub-program, and the like beforehand manually and performing the transfer by the group. However, in the method described in Japanese Patent Application Laid-Open No. 11-110029 11-110029, there is a problem in which it is necessary to define a group manually in advance, which requires a corresponding effort and cost.

### SUMMARY OF THE INVENTION

The present invention has been made to solve the aforementioned problem, and an object of the present invention is to provide a program storage device and a program storage system for transferring an appropriate program in advance to a numerical controller.

A program storage device according to an embodiment of the present invention is a program storage device that transfers a program or page to a numerical controller, the program storage device including: a statistical information collection unit that records at least a total number of times of transfer of the program or page transferred to the numerical controller; a prediction unit that predicts the program or page to be transferred subsequently, based on an execution state of the program in the numerical controller and the total number of times of transfer; and a program transfer control unit that transfers the predicted program or page.

In the program storage device according to an embodiment of the present invention, the statistical information collection unit records the program or page, another program or page transferred along with the program or page, and a total number of times of transfer of the another program or page in association with each other.

In the program storage device according to an embodiment of the present invention, the prediction unit predicts the program or page to be transferred based on the total number of times of transfer when a power-on is detected in the numerical controller.

A program storage system according to an embodiment of the present invention is a program storage system including a numerical controller and a program storage device that transfers a program or page to the numerical controller, in which the numerical controller includes: a statistical information collection unit that records at least a total number of times of request for the program or page requested to the program storage device; and a prediction unit that predicts the program or page to be requested subsequently, based on an execution state of the program in the numerical controller and the total number of times of request, and requests the program or page thus predicted, and the program storage device includes a program transfer control unit that transfers the program or page thus requested to the numerical controller.

In the program storage system according to an embodiment of the present invention, the statistical information collection unit records the program or page, another program or page requested along with the program or page, and a total number of times of request of the another program or page in association with each other.

In the program storage system according to an embodiment of the present invention, the prediction unit predicts the program or page to be requested based on the total number of times of request when a power-on is detected in the numerical controller.

According to the present invention, it is possible to provide a program storage device and a program storage system for transferring an appropriate program in advance to a numerical controller.

### BRIEF DESCRIPTION OF THE DRAWINGS

The foregoing and other objects and features of the present invention will become apparent from the following description of embodiments with reference to the accompanying drawings. Among the drawings:

FIG. 1 is a block diagram illustrating a configuration of a program storage system in the related art;

FIG. 2 is a diagram illustrating an operation of a program storage system in the related art;

FIG. 3 is a block diagram illustrating a hardware configuration of a program storage system according to a first embodiment;

FIG. 4 is a block diagram illustrating a functional configuration of the program storage system according to the first embodiment;

FIG. 5 is a flowchart illustrating an operation of the program storage system according to the first embodiment;

FIG. 6 is a block diagram illustrating a functional configuration of a program storage system according to a second embodiment; and

FIG. 7 is a flowchart illustrating an operation of the program storage system according to the second embodiment.

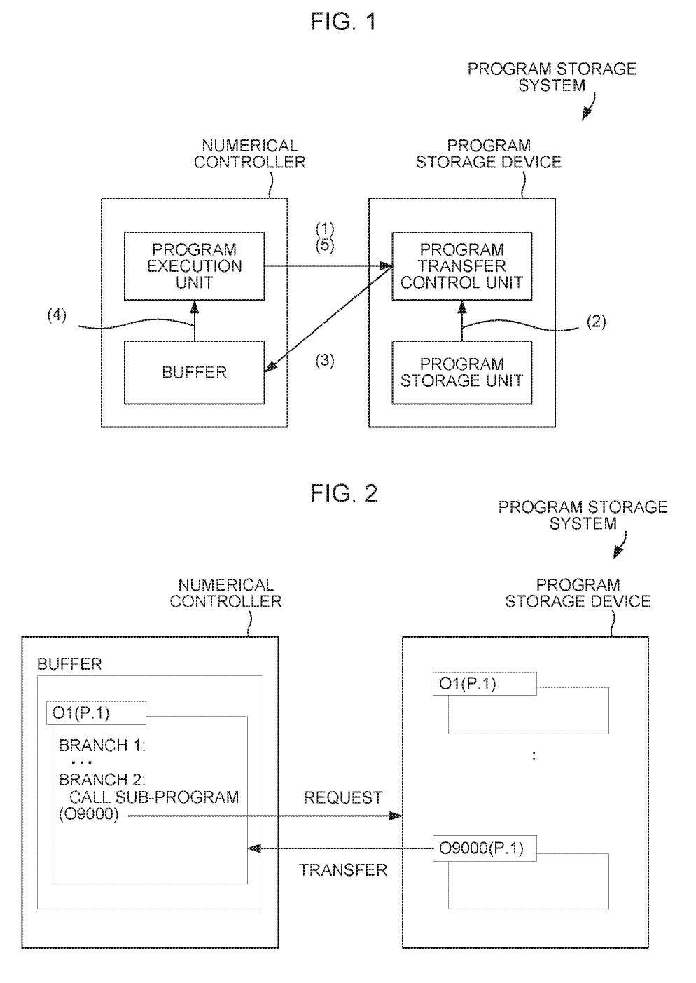

### DETAILED DESCRIPTION OF THE PREFERRED EMBODIMENTS

### First Embodiment

A program storage system 1 according to a first embodiment of the present invention will be described. The program storage system 1 includes a program storage device 10 and a numerical controller 20. In the first embodiment, the program storage device 10 predicts a program required by the numerical controller 20 and actively transfers the program.

The configuration of the program storage system 1 according to the first embodiment will be described.

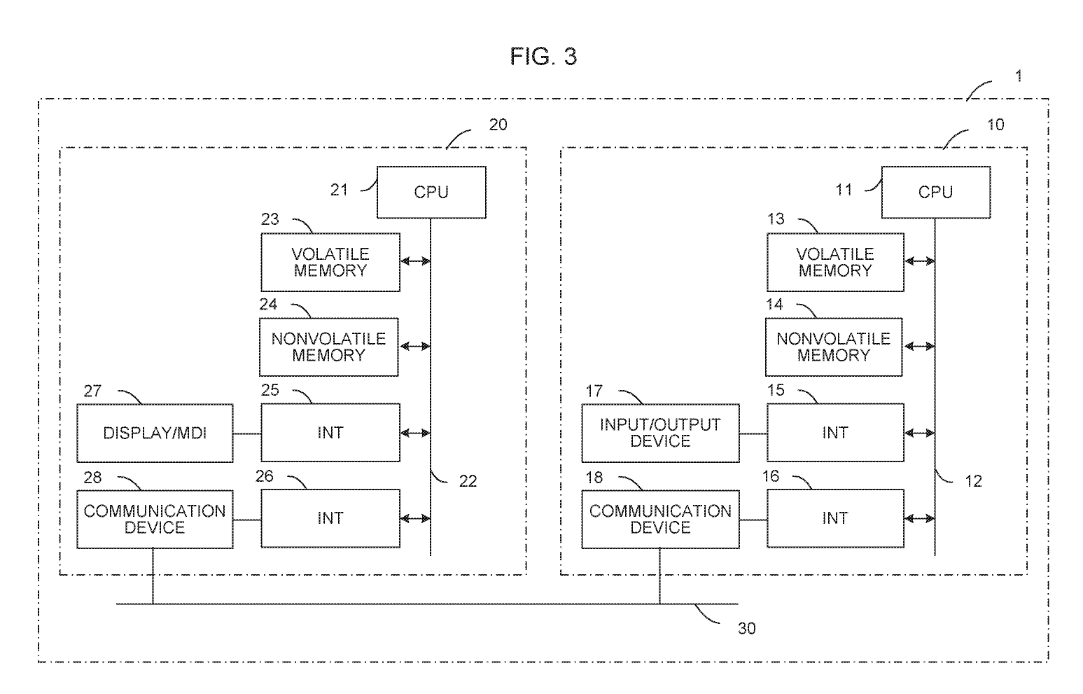

FIG. 3 is a schematic hardware configuration diagram of a main part of the program storage system 1 according to the first embodiment. The program storage system 1 includes the program storage device 10 and the numerical controller 20. The program storage device 10 is typically an information processing device such as a personal computer (PC) or a server. The program storage device 10 and the numerical controller 20 are connected via a communication network 30. The communication network 30 is configured by, for example, Ethernet (registered trademark).

A CPU 11 included in the program storage device 10 is a processor that controls the program storage device 10 as a whole. The CPU 11 reads out an operating system, application programs, and the like stored in a nonvolatile memory 14 via a bus 12, and controls the entire program storage device 10 according to the operating system, the application programs, and the like.

The nonvolatile memory 14 is a storage device that is kept in a storage state even when a power to the program storage device 10 is cut off, for example, by being backed up by a battery (not illustrated) or the like. The operating system, the application programs, data, and the like stored in the nonvolatile memory 14 may be developed in a volatile memory 13 at the time of use. The volatile memory 13 stores temporary calculation data, display data, communication data, and data input via an input/output device 17 and the like, in addition to the operating system, the application programs, the data, and the like, developed from the nonvolatile memory 14.

The input/output device 17 is a data input/output device such as a display or a keyboard. The command and data input from a keyboard of the input/output device 17 are passed to the CPU 11 via an interface 15. The display data output from the CPU 11 is displayed on a display of the input/output device 17 via the interface 15.

The communication device 18 is a communication interface that controls communication with the numerical controller 20. The communication data received from the communication network 30 to the communication device 18 is passed to the CPU 11 via an interface 16. Further, the communication data output from the CPU 11 is output to the communication network 30 by the communication device 18 via the interface 16.

A CPU 21 included in the numerical controller 20 is a processor that controls the numerical controller 20 as a whole. The CPU 21 reads system programs and the like stored in a nonvolatile memory 24 via a bus 22, and controls the entire program storage device 10 according to a system program and the like.

The nonvolatile memory 24 is a storage device that is kept in a storage state even when a power to the numerical controller 20 is cut off, for example, by being backed up by a battery (not illustrated) or the like. The system program and the like stored in the nonvolatile memory 24 may be developed in a volatile memory 23 at the time of use. The volatile memory 23 stores temporary calculation data, display data, communication data, data input via a display/MDI unit 27, and the like in addition to the system program and the like developed from the nonvolatile memory 24.

The display/MDI unit 27 is a data input/output device including a display, a keyboard, and the like. Commands and data input from the keyboard of the display/MDI unit 27 are passed to the CPU 21 via an interface 25. Further, the display data output from the CPU 21 is displayed on a display of the display/MDI unit 27 via the interface 25.

A communication device 28 is a communication interface that controls communication with the program storage device 10. The communication data received from the communication network 30 to the communication device 28 is passed to the CPU 21 via an interface 26. Further, the communication data output from the CPU 21 is output to the communication network 30 by the communication device 28 via the interface 26.

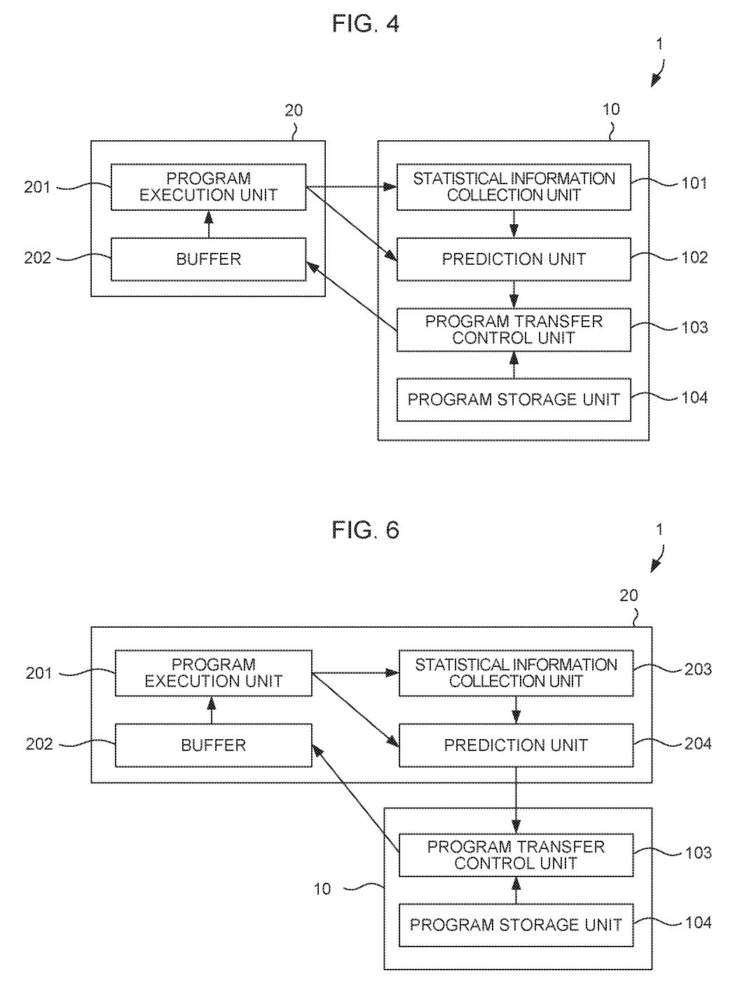

FIG. 4 is a block diagram illustrating a schematic functional configuration of the program storage system 1 according to the first embodiment.

The program storage device 10 includes a statistical information collection unit 101 that collects statistical information on program call, a prediction unit 102 that predicts a program with high possibility of being called by referring to the statistical information of the statistical information collection unit 101, a program transfer control unit 103 that actively transfers a program in accordance with the prediction of the prediction unit 102, and a program storage unit 104 that stores programs such as a main program and a sub-program.

The numerical controller 20 includes a buffer 202 that temporarily stores transferred programs, and a program execution unit 201 that sequentially reads out the programs from the buffer 202 to execute work processing and the like.

The operation of the program storage system 1 according to the first embodiment will be described.

FIG. 5 is a flowchart illustrating the operation of the program storage system 1 according to the first embodiment. The operation of the program storage system 1 is roughly divided into a preparation phase and a prediction phase.

Typically, the program storage system 1 performs an operation in the prediction phase after performing an operation in the preparation phase for a certain period of time. When performing the operation in the prediction phase, it is also possible to continue performing the operation in the preparation phase in parallel. Alternatively, the operation in the preparation phase and the operation in the prediction phase may be performed in parallel from the beginning, but some initial value can be given as statistical information (described later) in this case. As the initial value, for example, statistical information collected in another program storage system 1 that is already in operation or the like can be used.

### <Preparation Phase>

S101: while a program execution unit of the numerical controller 20 is executing the program, a statistical information collection unit 101 of the program storage device 10 collects statistical information on program call.

An example of the statistical information collected by the statistical information collection unit 101 is described below.

Total Number of Times of Transfer for Each Program or Page

In accordance with a request from the program execution unit 201 of the numerical controller 20 (related art) or in accordance with prediction of the prediction unit 102 (details will be described later), a total number of times of transfer of the program or page transferred by the program transfer control unit 103. The statistical information collection unit 101 records the total number of times of transfer each time the program or page is transferred.

Here, the program refers to a main program, a sub-program, or the like, which can be identified by a name of the program. The program is managed and transferred every predetermined unit, for example, every 512 bytes. This unit is called a page and can be identified by the number of the page.

Total Number of Times of Transfer of Another Program or Page Transferred Along with a Program or Page

When another program or page is transferred after a certain program or page is transferred, the statistical information collection unit 101 records both of them in association with each other. That is, in association with the program or page, another program or page transferred subsequently, and a total number of times of transfer per another program or page are recorded.

### <Prediction Phase>

S201: the program execution unit 201 of the numerical controller 20 executes the program. Alternatively, the numerical controller 20 is powered on.

S202: The prediction unit 102 of the program storage device 10 detects execution of a program or power-on in S201. The prediction unit 102 can acquire, for example, a name of the program being executed by the program execution unit 201, event information indicating power-on, and the like via an API corresponding to the numerical controller 20. Further, the prediction unit 102 can detect that the program execution unit 201 has requested transfer of a program or page also to specify a name of the program or the number of the page according to the technique in the related art.

S203: the prediction unit 102 refers to the statistical information created by the statistical information collection unit 101 and predicts the program or page to be transferred.

For example, in a case where the name of the program or the number of the page being executed or requested by the program execution unit 201 is acquired in S202, the prediction unit 102 refers to the statistical information created by the statistical information collection unit 101, and specifies another program or page having the largest total number of times of transfer among other programs or pages previously transferred along with the program or page being executed or requested. Thus, while executing a certain program or page, a program or page having a high possibility of being called subsequently is selected to be transferred.

Alternatively, when the power-on is detected in S202, the prediction unit 102 refers to the statistical information created by the statistical information collection unit 101 and specifies the program or page having the largest total number of times of transfer among the programs or pages. In this case, for example, a program such as a tool change module frequently used may be selected to be transferred.

S204: the program transfer control unit 103 acquires another program or page specified in S203 from the program storage unit 104. The program transfer control unit 103 transfers the acquired program or page to the buffer 202 of the numerical controller 20.

S205: the program or page transferred in S204 is stored in the buffer 202. The program execution unit 201 reads out the program or page from the buffer 202 and executes the program or page.

According to the present embodiment, based on the statistical information collected by the statistical information collection unit 101 of the program storage device 10, the prediction unit 102 specifies the program or page to be transferred, and the program transfer control unit 103 actively transfers the program or page. As a result, there are many cases where a program or page of a high statistical possibility of being executed subsequently are stored in advance in the buffer 202 of the numerical controller 20, thereby suppressing the latency and the generation of the transfer request by the program execution unit 201. As a result, it is possible to realize reduction in a cycle time and a factory of processing grade.

Further, since the program or page to be transferred is predicted by statistical processing in the present embodiment, it is possible to realize the embodiment with a small memory amount with a smaller calculation load as compared with the case of using a method such as machine learning.

### Second Embodiment

The program storage system 1 according to a second embodiment predicts a necessary program on the numerical controller 20 side and makes a transfer request in advance to the program storage device 10.

A configuration of the program storage system 1 according to the second embodiment will be described. Since a hardware configuration is the same as that of the first embodiment, its description is omitted.

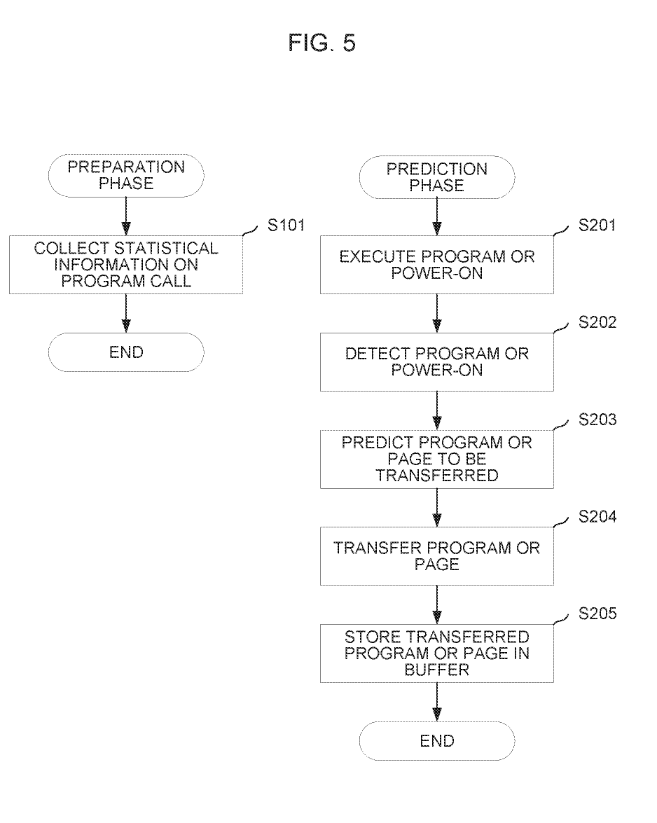

FIG. 6 is a block diagram illustrating a schematic functional configuration of a program storage system 1 according to the second embodiment.

The program storage device 10 includes a program transfer control unit 103 that transfers the program according to a request from the prediction unit 204 of the numerical controller 20, and a program storage unit 104 that stores the program such as a main program and a sub-program.

The numerical controller 20 includes a buffer 202 that temporarily stores the transferred program, a program execution unit 201 that sequentially reads out the program from the buffer 202 to execute a work processing and the like, a statistical information collection unit 203 that collects statistical information on program call, a prediction unit 204 that predicts a program with high possibility of being called by referring to the statistical information of the statistical information collection unit 203.

An operation of the program storage system 1 according to the second embodiment will be described.

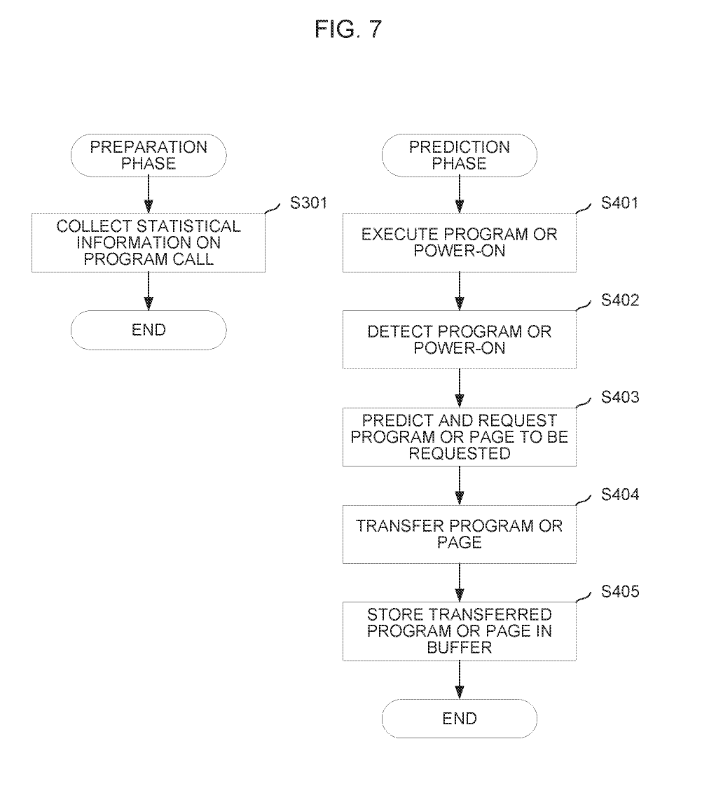

FIG. 7 is a flowchart illustrating the operation of the program storage system 1 according to the second embodiment.

<Preparation Phase>

S301: The statistical information collection unit 203 of the numerical controller 20 collects statistical information on program call while the program execution unit is executing the program.

An example of the statistical information collected by the statistical information collection unit 203 will be described below.

Total Number of Times of Requests for Each Program or Page

The detail requested by the program execution unit 201 of the numerical controller 20 (related art) or requested by the prediction unit 204 is a total number of times of request for a program or page to be described below. The statistical information collection unit 203 records the total number of times of request each time a program or page is requested.

Total Number of Times of Request of Another Program or Page Requested Along with a Program or Page

When another program or page is requested after a certain program or page is requested, the statistical information collection unit 101 records both of them in association with each other. That is, in association with the program or page, another program or page requested subsequently, and a total number of times of request per another program or page are recorded.

### <Prediction Phase>

S401: the program execution unit 201 of the numerical controller 20 executes the program. Alternatively, the numerical controller 20 is powered on.

S402: The prediction unit 204 detects the name of the program being executed in S401, the name of the program or the number of the page for which the program execution unit 201 has requested the transfer or the power-on.

S403: the prediction unit 204 refers to the statistical information created by the statistical information collection unit 203 and predicts the program or page to be transferred. Then, the program transfer control unit 103 of the program storage device 10 is requested to transfer the predicted program or page.

For example, in a case where the name of the program or the number of the page being executed or requested by the program execution unit 201 is acquired in S402, the prediction unit 204 refers to the statistical information created by the statistical information collection unit 203, and specifies another program or page having the largest total number of times of request among other programs or pages previously requested along with the program or page being executed or requested.

Alternatively, when the power-on is detected in S402, the prediction unit 204 refers to the statistical information created by the statistical information collection unit 101 and specifies the program or page having the largest total number of times of request among the programs or pages.

S404: the program transfer control unit 103 of the program storage device 10 acquires another program or page requested in S403 from the program storage unit 104. The program transfer control unit 103 transfers the acquired program or page to the buffer 202 of the numerical controller 20.

S405: the program or page transferred in S404 is stored in the buffer 202. The program execution unit 201 reads out a program or page from the buffer 202 and executes the program or page.

According to the present embodiment, since the numerical controller 20 includes the statistical information collection unit 203 and the prediction unit 204, the configuration of the program storage device 10 can be simplified as compared with the first embodiment. For example, since the program storage device 10 may be configured as a memory card or the like including the program transfer control unit 103 and the program storage unit 104, it is possible to realize the program storage system 1 at low cost.

The present invention is not limited to the aforementioned embodiments, but can be implemented in various aspects by an appropriate change. For example, in the aforementioned embodiments, the prediction unit 102 or 204 specified the program or page having the largest total number of times of transfer or request to be transferred or requested. However, the present invention is not limited to thereto but, for example, a program or page having an arbitrary number of times of transfer or request in an upper rank of the total number of times of transfer or request may be specified to be transferred or requested. As a result, it is possible to increase a hit ratio of the program or page stored in the buffer 202.

At this time, how many programs or pages in the upper rank should be transferred or requested may be dynamically determined depending on a degree of congestion of the communication network 30, a processing load of the numerical controller 20 and the like. That is, as the congestion degree and the processing load decrease, more programs or pages can be transferred or requested.

Further, in the aforementioned embodiments, the statistical information collection unit 101 or 203 records the total number of times of transfer or the total number of times of request of another program or page transferred or requested along with each program or page. However, the present invention is not limited thereto but, for example, a total number of times of transfer or request of another program or page transferred or requested along with each block of program. Here, the block is a line number of the program. As a result, it is possible to make more precise prediction.

1. A program storage device that transfers a program or page to a numerical controller, the program storage device comprising:
a statistical information collection unit that records at least a total number of times of transfer of the program or page transferred to the numerical controller;
a prediction unit that predicts the program or page to be transferred subsequently, based on an execution state of the program in the numerical controller and the total number of times of transfer; and
a program transfer control unit that transfers the predicted program or page.

2. The program storage device according to claim 1, wherein the statistical information collection unit records the program or page, another program or page transferred along with the program or page, and a total number of times of transfer of the another program or page in association with each other.

3. The program storage device according to claim 1, wherein the prediction unit predicts the program or page to be transferred based on the total number of times of transfer when a power-on is detected in the numerical controller.

4. A program storage system including a numerical controller and a program storage device that transfers a program or page to the numerical controller,
wherein the numerical controller includes:
a statistical information collection unit that records at least a total number of times of request for the program or page requested to the program storage device; and
a prediction unit that predicts the program or page to be requested subsequently, based on an execution state of the program in the numerical controller and the total number of times of request, and requests the program or page thus predicted, and
the program storage device includes:
a program transfer control unit that transfers the program or page thus requested to the numerical controller.

5. The program storage system according to claim 4, wherein the statistical information collection unit records the program or page, another program or page requested along with the program or page, and a total number of times of request of the another program or page in association with each other.

6. The program storage system according to claim 4, wherein the prediction unit predicts the program or page to be requested based on the total number of times of request when a power-on is detected in the numerical controller.
